(19) United States
(12) Patent Application Publication
(10) Pub. No.: US 2017/0217267 A1
(43) Pub. Date: Aug. 3, 2017

(54) Trailer Hitch Apparatus with Obtuse-Angled Elongate Winch Support Providing Improved Vehicle-End Profile and Hinged Door or Tailgate Clearance

(71) Applicant: Jimmie D. Vetkos, Grants Pass, OR (US)

(72) Inventor: Jimmie D. Vetkos, Grants Pass, OR (US)

(21) Appl. No.: 15/015,032

(22) Filed: Feb. 3, 2016

(51) Int. Cl. B60D 1/18; B66D 1/28; B60D 1/06

(52) U.S. Cl. CPC B60D 1/185; B60D 1/06; B66D 1/28

(57) ABSTRACT

Provided is a trailer hitch apparatus having a fixed, or a pivotally movable, upwardly extending obtuse-angled elongate winch support, which at an extended upper end has a winch mount configurable for mounting a winch atop thereof, such that the winch is operable spaced away from a vehicle-end profile and the winch and an upper portion of the obtuse-angled winch support provide improved or unrestricted vehicle hinged door or tailgate clearance. Embodiments of the apparatus upwardly extending obtuse-angled member are provided wherein a lower end thereof is rendered fixed, pivotal, hinged and/or reversible adjacent a normally horizontal elongate member configured at a normally vehicle-facing end to be inserted by a user within, and secured to, a trailer hitch receiver mounted on a vehicle, and configured at an opposite distal end having a trailer hitch ball mount, such that a trailer hitch ball and separate mounted winch are simultaneously or separately employable.

### CROSS-REFERENCE

This patent application claims the benefit of U.S. Provisional Application Ser. No. 62/112,064 filed Feb. 4, 2015, which application is incorporated in its entirety by this reference.

### FIELD OF THE INVENTION

The present invention relates to the field of winches, and of a winch-type configured mounted or mountable on an end of a wheeled vehicle such as a truck, ATV, search-and-rescue vehicle, automobile or van, or boat. More particularly, the invention relates to a removably securable trailer hitch apparatus configured with an elongate obtuse-angled winch support member which, in extending upwardly and rearwardly and/or optionally being configured to pivot, provides significantly improved clearance when mounted on any one of varied vehicle-end profiles, more-diverse installation compatibility and raised-positioned winch advantages.

### BACKGROUND OF THE INVENTION

While attempts have been made to provide a vehicle-end winch mounting apparatus that is compatible with typical trailer hitch receivers and compatible with the numerous vehicle-end profiles of varied types of vehicles, such attempts have not been optimal for either intended purpose.

For example, in a first approach disclosed in patent application U.S. Ser. No. 10/653,810 by Thompson, it can be seen in FIG. 1 and FIG. 2 of the application that from a compatibility and functional standpoint, there are a number of shortcomings to the '810 approach. For ease of reference FIGS. 5A and 5B of the detailed description section below include the Thompson FIG. 1 and FIG. 2 respectively and indicate such as ‘Prior Art’ (i.e., related art). For example, Thompson employs a relatively short first horizontal member which is single-pinned to a typical vehicle-end trailer hitch receiver, then a larger second horizontal member is single-pinned to the first horizontal member, then a trailer hitch ball mount is single-pinned to the second horizontal member, such that, there are three single-pinned joints before a trailer is even hitched to the apparatus. It is well-known that trailers and other towed apparatus can be subject to fish-tailing even when only a ball mount is mounted directly onto a vehicle-end. Thompson further compounds a likelihood of imparting or increasing unwanted and/or unsafe oscillations by the mounting of a relatively heavy winch at the highest point of his triple single-pinned apparatus. Accordingly, an initial half fish-tail motion in a first lateral direction can cause a corresponding lateral leaning or swinging of the triple single-pinned winch in the same direction, and a counter full fish-tail motion cause an even greater leaning and/or swinging in an opposite direction, such that the relatively heavy weight of the winch thereafter adds an increased momentum to each fish-tail motion. It is noted, that if the winch has to be removed before moving a vehicle with an attached trailer from one location to another to reduce such fish-tailing, that the ball mount is still left ‘double-jointed’ with a double single-pin-per-member configuration, which can also compound fish-tailing or oscillations even when no winch is installed.

A related problem to the Thompson triple single-pinned horizontal arrangement of components is, that any increase in their collective length will likely cause more play, which in turn, becomes a potential fish-tailing or oscillation multiplier. While a shortest combined length of the triple-pinned components might appear to be a remedial step, such a measure has its own shortcomings, as can be seen in Thompson FIG. 1 (included herein in FIG. 5A), wherein the mounted winch is located in such close proximity to a vehicle-end profile that a hinged tailgate or door of the vehicle is rendered essentially inoperable or significantly restricted. Further, any prospect of employing the winch in a reversed manner such that its winch cable and winch hook are unimpededly employable interiorly within the vehicle (as taught in the present application) is prohibited by the vehicle's hinged member forming a barrier between the winch and the vehicle's interior or truck bed. In Thompson FIG. 2 (included herein in FIG. 5B), it can also be seen that the employment of a “vertical tube” (or “substantially perpendicular” one) and a separate winch-plate mounting component extending upwardly therefrom, causes an abrupt change in the height of the Thompson apparatus particularly when adding the height, length and width of the winch onto the winch mounting plate. Such an arrangement renders a Thompson apparatus (mindful of the above shortcomings related to a lengthening of his triple single-pinned components), unemployable on numerous vehicles equipped with a recessed trailer hitch receiver, and/or recessed and having a vehicle-end profile above a recessed receiver unable to accommodate the abrupt height-change in the vertically-aligned components. It is noted that such recessed receivers and vehicle-end profiles are not limited to merely common on-road vehicles such as trucks and vans, but are also commonly encountered with off-road vehicles such ATVs, search-and-rescue, and other recreational vehicles.

Accordingly it would be advantageous to provide an apparatus configured removably securable within a trailer hitch receiver, or trailer hitch-like receiver, which is configured having an elongate horizontal member supporting an elongate upwardly extending winch support member, wherein both elongate members are each integrally formed lengthwise and are welded together to minimize or eliminate a compounding wobbling or play, and it is among the objects of the present invention to provide such improvements.

Additionally, it would be advantageous to provide an apparatus configured removably securable within a trailer hitch receiver, or trailer hitch-like receiver, in a typical manner, but is configured having an integrally formed elongate horizontal member supporting an elongate upwardly extending winch support member, wherein the elongate horizontal member extends from a receiver to a welded-on or affixed ball mount to eliminate unnecessary pinned coupling or joint(s), and it is among the objects of the present invention to provide such improvements.

It would also be advantageous to provide a removably securable apparatus for trailer hitch receivers, or trailer hitch-like receivers, which is configured having an integrally formed elongate horizontal member which supports an integrally formed elongate winch support member in both an upwardly extending and rearwardly extending manner at an obtuse angle extending from an upper side of the horizontal member to a winch mounting plate, to provide an enhanced clearance behind the upwardly directed components which is compatible with vehicle-end profiles of a significantly broader range of varied vehicle types, and providing configurations for accommodating positioning of vehicle-end hinged members, and it is among the objects of the present invention to provide such improvements.

Other attempts were made to adapt various types of frameworks to a horizontal member insertable into a trailer hitch receiver and equipped with an elongate vertical member, but did so in a manner such that the vertical member was closely proximate a vehicle-end hinged member (e.g., tailgate of a pickup truck).

Other objects will be apparent to one skilled in the art and still other objects will become apparent hereinafter.

### SUMMARY OF THE INVENTION

The present invention pertains to a removably securable trailer hitch apparatus equipped or configured with a significantly improved clearance obtuse-angled elongate winch support member. The elongate winch support member is configured to extend lengthwise (preferably integrally formed) both upwardly and rearwardly at an obtuse angle from an upper surface of a lower horizontal member normally aligned with a lengthwise axis of a trailer hitch receiver, preferably at an obtuse angle of not less than 110° e.g., 115°. Such triple-digit degree obtuse angles of the elongate winch support member provide a significantly improved clearance between each of varied vehicle-end profiles and an entire forward-facing (or vehicle-facing) surface of the elongate winch support member and a winch mounted thereabove, and does so when a removably securable end of a normally horizontal member of the apparatus, supporting the winch support member, is mounted within a trailer hitch receiver of one of a diverse range of vehicle types having one of varied vehicle-end profiles. For example, a removably securable trailer hitch apparatus equipped or configured with a significantly improved-clearance obtuse-angled elongate winch support member can be fitted onto more vehicle types having a vehicle-end profile which includes a hinged hatch, tailgate, liftgate, one or more doors, and the like, while also allowing a greater or total movement of the same.

An elongate obtuse angled winch support member is further configured having a principally horizontal upper end and principally horizontal lower end, such that the upper end allows a principally planar winch mounting plate and a winch mounted (or mountable) securably on the winch mounting plate to be aligned principally parallel to the horizontal lower end and preferably to at least one horizontal member of the apparatus. A normally horizontal member of the apparatus (preferably integrally formed) is configured equipped at a distal end with a ball mount and attached ball e.g., of a customary ball mount type and ball type, and configured at an opposite end removably securable within a trailer hitch receiver of a vehicle.

In certain of the preferred embodiments of the present invention the obtuse-angled elongate winch support member and a normally horizontal member configured supporting it are formed of a generally square tube material (preferably integrally formed), such as a square tube material type commonly used in the making of light-duty, medium-duty or heavy-duty trailer hitch receivers, or trailer hitch assemblies removably securable therein, or both. While such components are typically made of a quality steel material, it is noted that any material, alloy or composite material having similar properties and an equivalent or greater strength, is alternatively or additionally employable. For example, great strides are now being made in the development of graphene materials for varied purposes, and it is among the objects of the present invention to provide customers the option of having a trailer hitch apparatus with obtuse-angled elongate winch support made partly or entirely of graphene (or alloy or composite) when practicable to do so.

In another one of the preferred embodiments of the present invention the obtuse-angled elongate winch support member and a normally horizontal member configured supporting it are reinforced for increased pull-strength in an axis generally aligned with a normal pulling direction of a mounted winch (and/or reinforced transversely) by one or more gussets. In a first gusset reinforcement mode one or more generally triangular-shaped gussets are employed, formed of a square tube type similar to, or the same as, the winch support member and/or normally horizontal member. For example, a triangular-shaped gusset can be welded on opposite upright sides along two of its perimeter-sides into a rearward-facing acute angle formed adjacent the juncture of a lower end of a rearward-facing side of an obtuse-angled elongate winch support member and an upper side of a horizontal member supporting it (described below in greater detail). Similarly, a triangular-shaped gusset can additionally or alternatively be welded on opposite upright sides along two of its perimeter-sides into a forward-facing acute angle formed adjacent the juncture of an upper end of a vehicle-end facing side of an obtuse-angled elongate winch support member and a lower side of a principally planar winch mount plate (described below in greater detail).

Alternatively or additionally, one or more gusset plates preferably having a same or greater thickness as a wall of a winch support member or horizontal member, or both, can be provided, for example with each (or one) gusset plate, having a size and shape principally the same as an outward-facing side of a winch support member (with or without one or more of the foregoing welded triangular-shaped square tube gussets) and an outward-facing side portion of a normally horizontal member, and the gusset plate welded about all or most of its perimeter to the apparatus. Similarly, one, or a pair of, smaller triangular-shaped gusset plates made of such a thickness can additionally or alternatively be provided. For example, wherein each of a pair of the gussets is welded along two of its perimeter-sides into an aforementioned acute angles. In another mode, the option to have one of such elongate gusset plates aligned and welded onto one or both outward-facing sides of an elongate obtuse-angled winch support member is provided (with or without the plate also matching the shape of one or more of the foregoing welded triangular-shaped square tube gussets), including the option to do so such that a lower portion of the one or more elongate gusset plates are not welded to a normally horizontal member. In the latter case, an elongate obtuse-angled winch support member and its outer elongate gusset plate, or pair of elongate gusset plates, can be pivotally configured e.g., by a hinge, pivot joint or hinge-like arrangement pivotally coupling, linking or associating, the two members together, which allows the elongate winch support member, gusset plate(s) and a winch mounted thereabove to be pivoted rearwardly away from, and maximize their clearance from, a vehicle-end profile of one of varied vehicles, preferably such that the elongate winch support member and gusset plate(s) when fully rearwardly pivoted, are positioned to a horizontal or near-horizontal state (described below in greater detail).

In operation, each of the foregoing embodiments provides a horizontal member having an end configured to be removably secured within a trailer hitch receiver mounted on an end or end-underside of a vehicle-end of one of a diverse range of vehicles e.g., mounted in a customary manner. Once mounted, a winch, also mounted atop an elongate obtuse-angled winch support member, as previously described, is positioned at a height advantageously employable for varied tasks and in a manner providing improved clearance from, a vehicle-end profile of one of varied vehicles and/or hinged member thereof. Thus, the winch is located at a height which is more convenient to work with and in less tight quarters. The winch cable and hook are also located at a height making it easier for them to be attached at a similar height to, and to pull on, any one of various items, or vehicles, in an unimpeded or unrestricted manner e.g., up a ramp of, or onto, a flatbed trailer, or onto trailer having a surrounding slatted fence. For example, in the latter case, the cable and hook of the winch are positioned at a height making it easy to thread both through a relatively wide gap in the slatted fence in a manner substantially reducing or entirely eliminating cable wear and tear, and abrasion, thus prolonging its service life, and reducing an injury that can be caused by a frayed wire cable. In either trailer arrangement, or with a boat or other recreational vehicle-specific trailer, the winch cable and hook when moved from a retracted state height to an extended state are employable at a same or similar height to connect with and pull onto a trailer in an unimpeded manner (but not limited to), any one or more of the following: a boat onto a boat trailer, a jet ski, an ATV, a dune buggy, a tractor, a motorcycle, a golf cart, an electric cart, a stranded or inoperable vehicle, a gas or electric powered automobile, a snow mobile, furniture, an appliance, a sound system, music equipment, staging equipment, a bundle of twigs and/or small branches, one or more logs or cut logs, boxed object(s), barrels, a pallet, a small aircraft, a sailplane, gyrocopter, and the like.

In operation, the foregoing embodiment having an elongate obtuse-angled winch support member and winch configured to concurrently pivot, is also pivotal to a lowest-height advantageously employable for varied tasks and in a manner providing maximum or optimal clearance from a vehicle-end profile of one of varied vehicles and/or hinged member thereof. For example, a momentary or sustained pivoting of the elongate obtuse-angled winch support member and winch to a lowest, or horizontal, position is quickly achieved by a removal of a slidable lock pin from an aperture which positively retains the winch support member at its normally obtuse angled position. Thus pivoted, any of varied hinged hatches, tailgates, liftgates, one or more doors, and the like, on any one of varied vehicle-end profiles, are each rendered entirely operable in their normal mode(s) of operation.

In another one of the preferred embodiments a winch is configured reversible, by a lower horizontal portion of an aforementioned single gusset plate, or each of a pair of gusset plates, being equipped with, or configured to include, two horizontally (or laterally) spaced apart lock-pin apertures which are alignable with similar spaced apart lock-pin apertures of a lower horizontal member supporting an elongate obtuse-angled winch support member. In a first mode, a mid-most lock-pin removably securable within a respective lock-pin aperture is alternatively or optionally employed to function as a pivot joint, allowing the elongate obtuse-angled winch support member to be used principally in a previously described manner. In a second mode, a removal of both lock-pins allows an elongate obtuse-angled winch support member and a winch mounted thereabove to be separated entirely from a horizontal member supporting it, and rotated 180° such that the two horizontally spaced apart lock-pin apertures of the single gusset plate, or of each of the pair of gusset plates, align with the similar spaced apart lock-pin apertures of the lower horizontal member, allowing the two lock-pins to be reinserted into their respective lock-pin apertures, which in turn, supports the elongate obtuse-angled winch support member and winch mounted thereabove, in a reversed orientation. Thereafter the winch, winch cable and hook (or other fastener) can be employed to facilitate a removal one or more aforementioned items, objects, goods, material and the like, from an interior of a truck bed or van, or any among varied types of vehicles. In a third mode either of the two lock-pins can be removed allowing the elongate obtuse-angled winch support member and winch mounted thereabove to pivot in a manner previously described, or a similar manner.

Alternatively or additionally, a winch can be configured selectively rotatable at an upper end of an elongate obtuse-angled winch support member. For example, by a lower surface of a winch principally planar mounting plate being equipped with a downwardly extending multi-sided receiver-insert configured to be inserted into a corresponding complementary-shaped vertical or upright receiver or socket e.g., wherein the latter is welded or formed within an upper end of a winch support member. A multi-sided receiver-insert can be made securable within an upright or vertical receiver or socket in a removably securable manner by suitable removable fasteners, for example, by one or more set screws, or one or more spring-loaded pins that can be momentarily pulled to disengage a respective aperture and released to selectively engage the same. Alternatively, one or more lock-pins can be configured transversely insertable through a corresponding one or more apertures located at an upper end of an elongate obtuse-angled winch support member and aperture pairs formed in one or more opposite sides of a downwardly extending multi-sided member. For example, a winch-mount plate downwardly extending multi-side member e.g., with aperture pairs formed in each of its opposite sides, can be a suitable length of square tube of a size designed to slidably fit and be removably secured within an interior of a corresponding vertical or upright square tube receiver of a similar length. Thus configured, a winch of the present invention is rotatable 180° (or for pulling or tensioning a lightweight load 90°) by simply releasing any fastener(s), raising the winch-mount plate downwardly extending multi-side member out of its receiver, rotating it 180° (or 90°), reinserting it into the receiver, and re-fastening it in place. It is noted that a downwardly extending multi-sided member and corresponding vertical receiver or socket can be configured having other complementary shapes including, but not limited to: being trapezoidal, having a parallelogram shape, having a polygonal cross-section e.g., with a number of sides other than four (or a square tube) such as being six-sided/or hexagonal in shape (i.e., configured rotatable at 45° increments), a downwardly extending multi-side member can be sized and shaped to match and slidably fit within a size and shape of an interior volume of an upper end of an elongate obtuse-angled winch support member, and the like.

The foregoing has outlined rather broadly the features and technical advantages of the present invention so that those skilled in the art may better understand the detailed description of the invention that follows. Additional features and advantages of the invention will be described hereinafter that will form the subject of the claims of the invention. Those skilled in the art should appreciate that they may readily use the conception and the specific embodiments disclosed as a basis for modifying or designing other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIGS. 1A-1E are a series of two-dimensional views each depicting a different side of a trailer hitch apparatus with an obtuse-angled elongate winch support member of the present invention, wherein FIG. 1A a side view, FIG. 1B is a rearward-facing side, FIG. 1C is a top side, FIG. 1D is a bottom side, and FIG. 1E is a forward-facing or vehicle-facing side.

FIGS. 2A-2E are a series of two-dimensional views similar to FIGS. 1A-1E depicting a trailer hitch apparatus with an obtuse-angled elongate winch support member of the present invention having one or more reinforcing elongate gusset plates. Wherein FIG. 2A a side view, FIG. 2B is a rearward-facing side, FIG. 2C is a top side, FIG. 2D is a bottom side, and FIG. 2E is a forward-facing or vehicle-facing side.

FIGS. 3A-3D are a series of two-dimensional views depicting a trailer hitch apparatus with an obtuse-angled elongate winch support member of the present invention having one or more reinforcing elongate gusset plates wherein a lower portion of the winch support member and gusset plate(s) are configured to pivot between a normal obtuse-angled position depicted in FIG. 3A and a horizontal or near-horizontal position depicted in FIG. 3C. FIG. 3A is a side view, FIG. 3B is a rearward-facing side view, FIG. 3B and FIG. 3D are rearward-facing side views of FIGS. 3A and 3C respectively.

FIGS. 4A-4D are two-dimensional views depicting a trailer hitch apparatus with an obtuse-angled elongate winch support member of the present invention comprising one or more elongate gusset plates, wherein the obtuse-angled elongate winch support member is configured to pivot within a pivot range, by a lower horizontal portion of the elongate gusset plate(s) being configured to pivot about a selected first lock-pin of a pair of lock-pins, by a removal of a second lock-pin. In FIG. 4A either aperture of the lower horizontal portion can be equipped with a releasably fastenable lock-pin or fastener and thereby be made pivotal. In FIG. 4B an aperture nearest a ball mount has an engaged and secured lock-pin. FIGS. 4C and 4D depict how an obtuse-angled elongate winch support member is optionally made reversible and similarly made pivotal.

FIGS. 5A and 5B are two three-dimensional figures of a “Prior Art” reference ‘Thompson Ser. No. 10/653,810’ namely: “FIG. 1” and “FIG. 2” (respectively).

FIGS. 6A-6D and 6F are two-dimensional views of an upper end portion of an elongate obtuse-angled winch support member equipped with an upright multi-sided receiver or socket configured to slidably receive and selectively retain a removably securable multi-sided receiver-insert having a same number of sides a the receiver or socket. FIGS. 6B and 6E depict a multi-sided receiver-insert lifted out of a corresponding receiver or socket to allow a 90° or 180° rotating of a winch prior to being inserted into a receiver or socket, as depicted in FIGS. 6C and 6F respectively.

### DETAILED DESCRIPTION OF THE PREFERRED EMBODIMENTS

For the purpose of improving clarity of understanding, one or more reference numerals employed in an earlier drawing figure may be repeated in one or more subsequent figures.

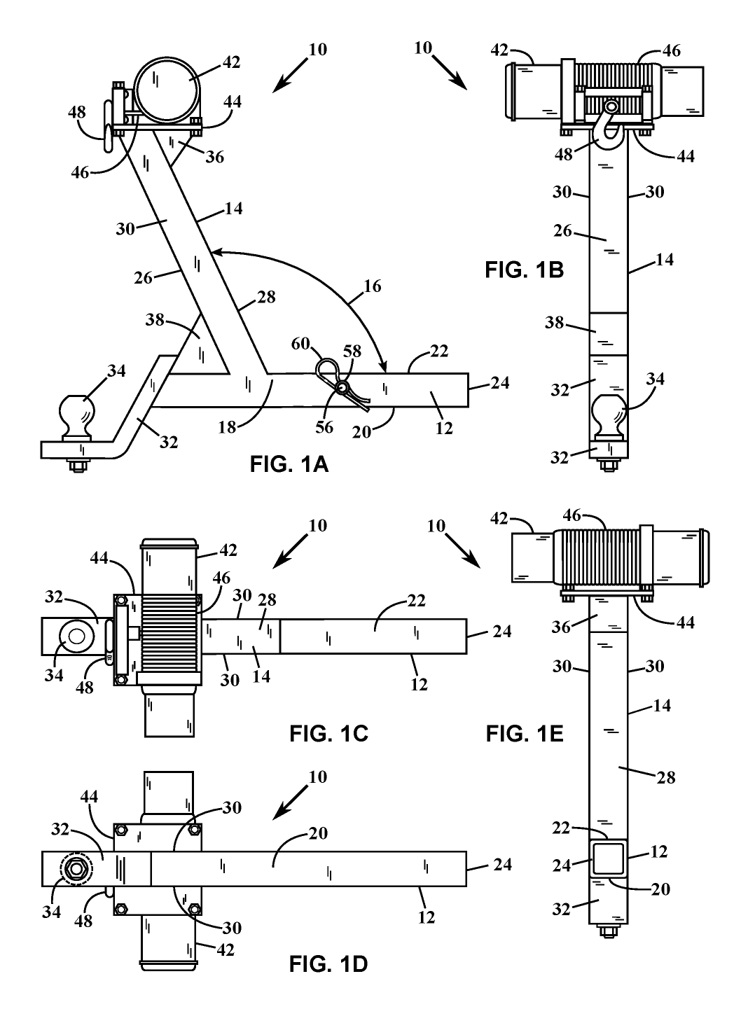

In reference to FIG. 1A-1E, a series of two-dimensional views each depict a different side of a trailer hitch apparatus with an obtuse-angled elongate winch support member 10 of the present invention. In the side view of FIG. 1A, an elongate obtuse-angled winch support member 14 (hereinafter referred to as “an elongate obtuse-angled support member 14” or “winch support member 14”) is configured extending upwardly and outwardly from an upper surface portion of a horizontal member 12 to a bottom side of a winch mounting plate 44, which in turn is shown supporting a mounted winch 42. The winch support member 14 is extended at the elongate obtuse-angle to provide (when mounted to a vehicle-end trailer hitch receiver) a significantly improved clearance between each of varied vehicle-end profiles and an entire forward-facing surface 28 of the elongate winch support and a winch 42 mounted thereabove. An obtuse angle 16 e.g., of 115°, is represented by an arced line having arrow-heads located at opposite ends. An obtuse angle vertex 18 is depicted proximate an upper side 22 of horizontal member 12 (opposite a lower side 20 of member 12). Preferably obtuse-angled elongate winch support member 14 and horizontal member 12 are each integrally formed to optimize their strength e.g., lengthwise. However alternatively, an obtuse-angled elongate winch support member 14 can be configured telescopically positionable. For example, such that a smaller cross-section square tube of suitable length slidably fits within an upper end interior portion of the angled winch support member 14, is configured positionable between two or more heights and retainable at a positioned height by one or more suitable fasteners. For example, by one or more lock-pins configured transversely insertable through a corresponding one or more apertures or aperture pairs located along a lengthwise portion of the angled winch support member and located along a lengthwise portion of the smaller cross-section square tube (or by one or more other types of fasteners described hereinafter).

Preferably an upper end and a lower end of an elongate obtuse-angled winch support member 14 (when installed for use) are each configured, formed or made principally horizontal, such that a winch mounting plate 44, and a winch 42 mounted thereabove, are supported principally in a horizontal plane parallel to the lower end of the obtuse-angled winch support member, and/or a welded seam around the perimeter of the lower end. To further increase the pull-strength of an obtuse-angled elongate winch support member 14 and/or one or more joints thereof, one or more generally triangular shaped gussets can be employed made of a metal suitable to be welded into place e.g., as shown in FIG. 1A. For example, an upper triangular gusset 36 preferably formed of a square tube of a same or similar size and material as winch support member 14, or horizontal member 12, or both (thus a multi-sided gusset). Additionally or alternatively, a generally triangular shaped gusset 38 can be provided, made of a metal plate material suitable to be welded into place e.g., as shown in FIG. 1A and having a suitable thickness such as light-duty 0.125″, medium-duty 0.188″, or heavy-duty 0.250″ thickness, and the like.

In FIG. 1A a winch 42 is depicted having a winch cable 46 (portion) extending outwardly and attached to a winch hook 48 (or other fastener not shown) which is shown normally aligned above a portion of a ball mount 32 (having a mounted ball 34) which is welded or affixed to a distal end of horizontal member 12 to eliminate play between a ball mount 32 and a horizontal member 12. Horizontal member 12 is configured at an opposite end having a receiver-insertion end 24 which is removably securable e.g., in a customary manner, within a trailer hitch receiver (not shown) mounted on an end of any among varied types of vehicles. For example, an elongate portion of horizontal member 12 can be selectively retained within a corresponding trailer hitch receiver by an aligning of a pin-aperture 58 with a respective pin-aperture of the trailer hitch receiver, an inserting of a lock-pin 56 therethrough, and a placing of a lock-pin keeper 60 on the lock-pin. To remove the apparatus, the keeper and then the pin-lock are removed, allowing the apparatus to be removed from the trailer hitch receiver. As seen in FIG. 1A, an elongate obtuse-angled winch support member 14 has a rearward-facing side 26, opposite outward-facing sides 30 (see also FIGS. 1B-1E) and a forward-facing side 28. See FIGS. 1B-1E for side, front, top, bottom and rear views (respectively) of the embodiment depicted in FIG. 1A.

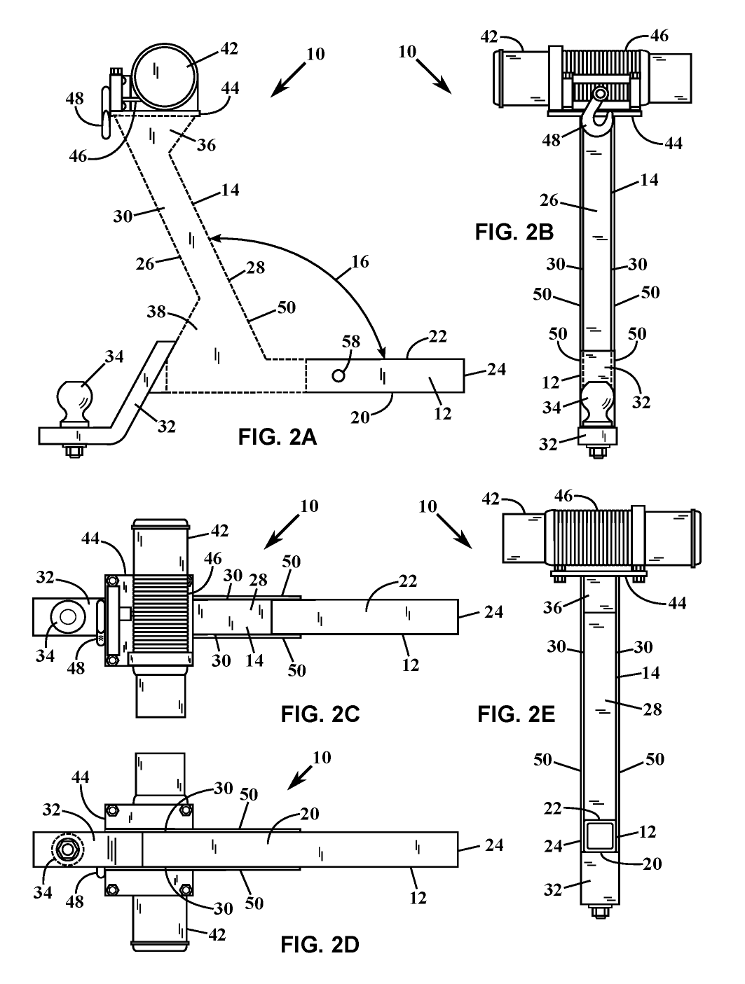

In reference to FIGS. 2A-2E, a series of two-dimensional views are provided which are similar to and relate to FIGS. 1A-1E, wherein each of FIGS. 2A-2E depict an elongate obtuse-angled winch support member 14 and a horizontal member 12 both individually and collectively being reinforced by a single, or by a pair of, attached elongate gusset plate(s) 50 of suitable thickness e.g., at least as thick as a wall thickness of a winch support member 14 or horizontal member 12. Preferably, an elongate gusset plate 50 is sized and shaped to closely match or approximate the size and shape of a respective elongate obtuse-angled winch support member 14 (with or without one or more of the foregoing triangular gussets) and at least an outward-facing side portion of the horizontal member 12 as wide, or somewhat wider, than the gusset plate width adjacent the horizontal member upper side 22. Thus configured, a gusset plate 50 can be aligned and fastened to members 14 and 12 by suitable fastening means e.g., by a welding of at least a majority of a gusset perimeter to the members. Alternatively, one or more other fastening means can be employed along a majority of a gusset perimeter to positively secure a gusset plate 50 to members 14 and 12, including, but not limited to, a series of rivets, bolts, machine screws, pins, or an adhesive, an epoxy, a sonic-welding, and the like. In FIG. 2A a lower horizontal end portion of an elongate gusset plate 50 is shown extending somewhat laterally such that an obtuse-angle 16 is incorporated into the gusset. See also See FIGS. 2B-2E for front, top, bottom and rear views (respectively) of the gusset plate reinforcing embodiment depicted in FIG. 2A.

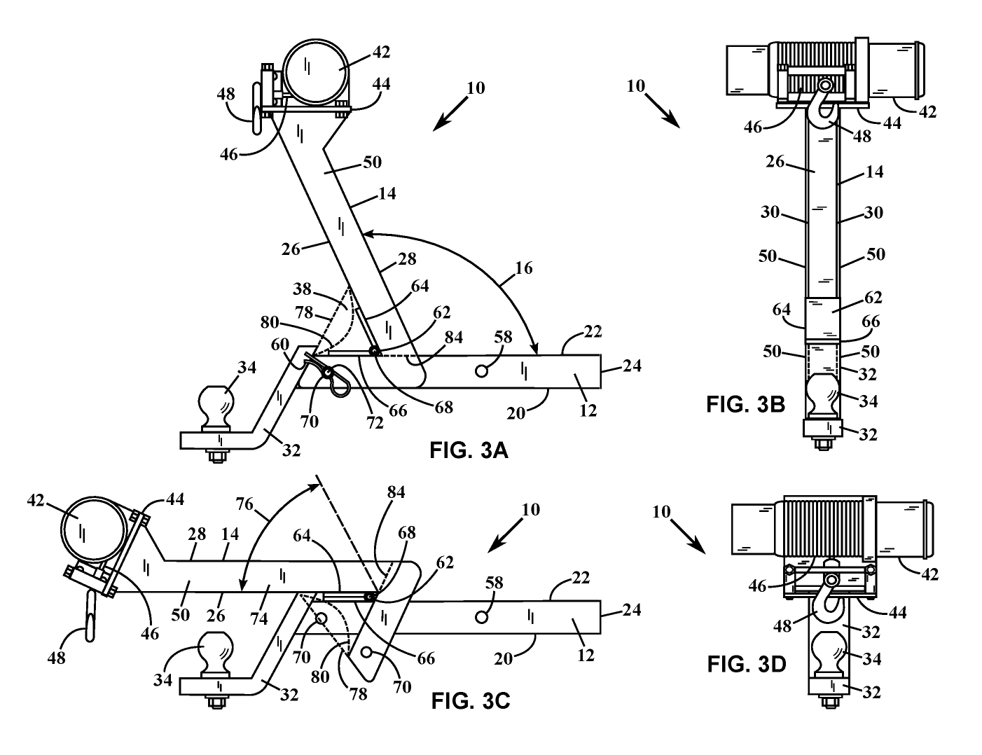

In reference to FIGS. 3A-3E, a series of two-dimensional views depicts a trailer hitch apparatus wherein an elongate winch support member 10 and mounted winch 42 normally retained at an obtuse-angle 16, are configured to pivot within a pivot range 76. Preferably, either or both outward-facing sides 30 of only an elongate obtuse-angled winch support member 14 are configured having a welded on (or otherwise fastened or affixed) single, or pair of reinforcing elongate gusset plates 50 wherein, the lower normally horizontal portion of a single, or of a pair of reinforcing gusset plates 50 are not welded, fastened or affixed to outward-facing sides of elongate horizontal member 12. Instead, an elongate obtuse-angled winch support member 14 and a single, or pair of gusset plate(s) 50 each supporting at an upper end a mounted winch 42, are normally retained at an obtuse angle 16, by one or more suitable fasteners which function as a pivot stop, e.g., a lock-pin 72 retained within and extending through a gusset plate pin-aperture 70 and a corresponding aligned pin-aperture 70 located in an aft portion of an elongate horizontal member 12. To selectively provide a pivoting of the elongate winch support member 14 and mounted winch 42 the lock-pin 72 is removed, allowing a pivoting of both (14 and 42) downwardly until an upper portion of one or more stationary components of the apparatus serve as a pivot lowering stop, and thereafter, allowing a pivoting of both upwardly until an obtuse-angled winch support member lower end 84 comes into contact with an upper side 22 of horizontal member 12 serves as an obtuse-angle pivot stop (which in turn, allows a re-insertion of a lock-pin 72, retaining 14 and 42 at an obtuse angle 16). Thus a pivot point or pivot joint, such as a hinge pin pivot point 68 hinge, located within an outer portion of an elongate horizontal member 12 (e.g., within an outer half portion) provides a pivot range 76, preferably between a normal obtuse-angled position depicted in FIG. 3A and a horizontal or near-horizontal position depicted in FIG. 3C, which, when pivoted to a lowered pivot position provides, a maximum or optimal clearance between a pivoted member 14/mounted winch 42, and vehicle-end profiles of varied types of vehicles and/or one or more hinged members thereof.

As depicted in FIGS. 3A-3D, a durable hinge 62 is employed (e.g., comprised of a cold rolled steel) wherein a hinge upper leaf 64 is welded to a normally rearward-facing surface 26 lower end portion, and a hinge lower leaf 66 is welded to a portion of an upper side 22 of an elongate horizontal member 12, such that a hinge pivot point 68 is preferably located closely proximate a vertex of a rearward-facing acute angle proximate a lower end of rearward-facing side 26. Additionally or optionally, a reinforcing triangular gusset portion can be integrally formed into, or a lower gusset 38 (of type previously described, or similar thereto) can be welded into, a lower portion (e.g., an acute angle portion) of a single, or a pair of, elongate gusset plate(s) 50 as depicted FIGS. 3A and 3C. Additionally or optionally, a non-welded exterior side of the lower portion can be formed or cut having a triangular perimeter-side 78, or a contoured or curved perimeter side 80 as depicted in FIGS. 3A and 3C. An elongate obtuse-angled support member 14, gusset plate(s) 50 and winch 42 mounted thereabove, are retained at a normal obtuse angle 16 by a lock-pin 72 operatively engaged within apertures 70 e.g., as shown in FIG. 3A (a front view is depicted in FIG. 3B) such that a removal of the lock-pin 70 allows a pivot-lowering of member 14, gusset plate(s) 50 and winch 42 through a pivot range 76 to a lowest pivot position e.g., as shown in FIG. 3C and FIG. 3D. A pivot-raising of the same to a highest pivot point (e.g., at obtuse angle 16) as shown in FIG. 3A and FIG. 3B, allows for a re-insertion of a lock-pin 72, which in turn, retains the elongate obtuse-angle member 14, gusset plate(s) 50 and winch 42 mounted thereabove, in the highest pivot position.

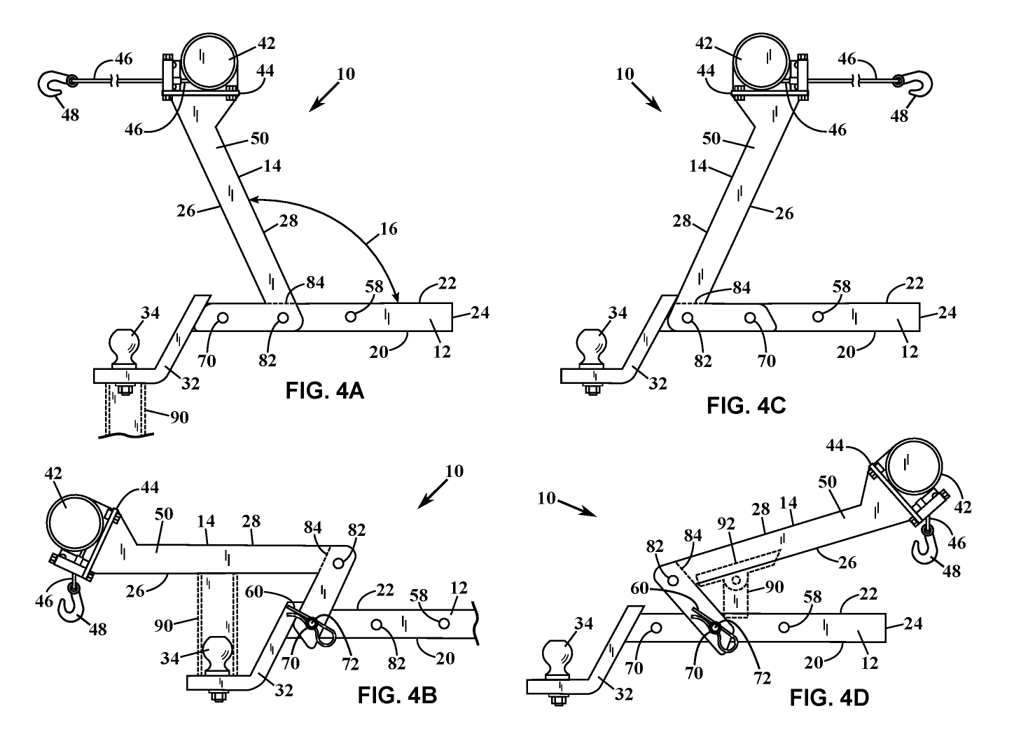

It is noted that other pivot arrangements, not requiring a hinge 62, are also provided and made available for use, e.g., as depicted in FIGS. 4A-4D. For example, in each of the figures a lower normally horizontal portion of a single, or a pair of, elongate gusset plate(s) 50 are configured pivot-enabled by including a pair (or a plurality) of spaced apart gusset plate pin-apertures in a respective lower horizontal portion e.g., a gusset plate pin-aperture 70 and pin-aperture 82. While for illustrative purposes the apertures are depicted having certain spacing between them, it is noted that various spacing options are also possible. For example in FIG. 4A, a moving of an aperture 82 laterally somewhat, between a third and half way point of the normally horizontal portion, allows a rearward-facing side 26 of an elongate obtuse-angled winch support member 14 to align adjacent or flush with an upper side 22 of the elongate horizontal member 12 when member 14 is pivoted to a lowest position. Thus, the aperture spacing is adjustable according to a desired pivoted position and a lowest pivoted position of a member 14, and a desired spacing between a rearward-facing side 26 and an upper side 22. In each case, an inserting of a first lock-pin 72 extending through pin-apertures 70 and a second lock-pin extending through a gusset plate aperture 82, and each lock-pin fully extending through corresponding aligned-apertures of an elongate horizontal member 12, retain an elongate obtuse-angle member 14, gusset plate(s) 50 and winch 42 mounted thereabove, in a highest pivot position, e.g., as shown in FIG. 4A and FIG. 4C.

To quickly convert the dual lock-pinned assembly into a pivot-enabled assembly and provide a pivoting of the assembly over a pivot range, a first releasably fastenable lock-pin or fastener is removed while a second releasably fastenable lock-pin or fastener (hereinafter referred to as ‘lock-pin’) is left in place to serve as a pivot point, or pivot joint. Thus, a quick removal of either (only one) lock-pin, such as a lock-pin 72 in apertures 70, provides for a pivoting of an elongate obtuse-angle member 14, gusset plate(s) 50 and winch 42 (assembly) through a pivot range having highest normally pivot position e.g., as depicted in FIGS. 4A and 4C, and a lowest pivot position e.g., as depicted in FIGS. 4B and 4D, and to do in a similar previously described manner, providing a maximum or optimal clearance between a pivoted member 14/mounted winch 42, and vehicle-end profiles of varied types of vehicles and/or one or more hinged members thereof.

To quickly convert a single or dual lock-pinned assembly into a separably employable assembly or a reversible assembly, both lock-pins are removed from their respective apertures (70 and 82) as shown in FIG. 4A, which allows for a ‘quick-removal’ of an elongate obtuse-angle member 14, gusset plate(s) 50 and winch 42 assembly from an elongate horizontal member 12 e.g., to provide a separably employable use of an assembly entirely independent of the elongate horizontal member 12. In a ‘reversible’ mode, a removal of both lock-pins, allows for a ‘quick-reversing’ of an elongate obtuse-angled member 14, gusset plate(s) 50 and winch 42, by lifting the assembly up a few inches, rotating it 180°, then aligning the lower end of a single, or pair of gusset plate(s) 50 such that each of the dual-apertures are aligned with their respective aperture in an elongate horizontal member 12 and fully re-inserting both of the lock-pins in their respective apertures (70 and 82). Thus configured, the forward-facing side 26, rearward-facing side 28, obtuse-angle 16 and mounted winch 42 (i.e., all components of the assembly) are reversed and extend upwardly and inwardly toward a vehicle end as depicted in FIG. 4C. Thus configured, a winch 42 (with its cable 46 and fastener 48) e.g., facing a truck bed or an interior of a vehicle (such as a large or small van) can be employed to facilitate a removal and/or a positioning of one or more heavier objects, boxes or pallets, and the like, from, or within, the truck bed or vehicle. If the one or more objects are removed and placed nearby, a trailer or other towable vehicle (hereinafter referred to generically as “trailer”) already attached to a ball 34, or one available to be thus attached, can be moved by the truck or vehicle such that a positioning of a trailer end near the objects allows an assembly (e.g., 14, 15, 44 and 42) as depicted in FIG. 4A to be employed to facilitate a pulling the same objects onto, or up a ramp onto, the bed or floor of the trailer.

Additionally, the reversed components are pivot-enabled over a pivot range e.g., by a removal of a single lock-pin e.g., lock-pin 82, to be pivoted to a lowered pivot position, for example to rest on a tailgate, a bed or floor of a truck, or a floor of a van, and the like.

FIGS. 4A, 4B and 4D further depict an option to employ one or more reinforcing upright support members 90 in a manner which enhances one or more functions of the apparatus 10. For example, a reinforcing upright support member 90 (whether of fixed height or adjustable in height) can be located vertical and intermediate a surface a vehicle is on and an underside of a ball mount 32 of an apparatus 10 removably secured in a trailer hitch receiver of the vehicle, as seen in FIG. 4A (optionally having a lower end which is insertable into, and made adjustable in height within, a jack stand). Thus configured, the upright support member 90 shares in supporting a downward load imparted to an elongate horizontal member 12 and vehicle-end mounted trailer hitch receiver when a winch 42 is being employed. Optionally an upper end can be polygonal for example, six-sided such that it fits snugly around a hex-shaped nut. In another mode, an upright support member 90 as depicted in FIG. 4B, such as a cut length of round or square tube, pipe, or the like (preferably having an inner diameter sized to snuggly fit around a mounted ball 34) can be employed to provide a vertical support of the elongate gusset plate(s) 50 and associated components e.g., to be employed in a small crane-like manner, for example to lift one or more objects or ends thereof (or used concurrently with the upright support member 90 depicted in FIG. 4A). Additionally or optionally, a trailer hitch or hitch-like receiver can be mounted at a higher height on a vehicle in a fixed manner or a pivot-arm or swing-arm (in addition to, or instead of, one mounted under a vehicle-end), for example, mounted onto an upright framework located adjacent a pickup truck bed, or associated with a wall of a van or truck-van (and the like), and provide one or more insertion ports to receive a removably securable apparatus 10 end of the present invention e.g., to thereby provide a higher and more versatile fixed or swing-arm mounted crane and winch pull point(s). FIG. 4D further depicts an option to employ a reinforcing upright support member 90 whether of fixed height, adjustable in height, or further equipped with a cradle 92 or optionally a pivot-enabled upper cradle. Thus configured, the elongate gusset plate(s) 50 and associated concurrently positionable components thereof are provided a range of different pivot adjustments.

It is noted that in each of the preferred embodiments previously described a wheeled-trailer, sled, or other towable vehicle or device, selectable from varied types of such, can remain hitched to a ball 34 of a ball mount 32 before, after and while a winch 42 is employed for one or more tasks, and the towing vehicle driven from one location to one or more other locations, such that the ball 32 and winch 42 are concurrently employable, individually employable and/or in the removable-components embodiments separately employable, at any time and any of the locations. For example, to work with a trailer there is no need to further install and secure by a lock-pin a trailer hitch ball mount and ball configured removably securable in a distal end of a horizontal member already mounted in a trailer hitch receiver. Furthermore, by providing an elongate horizontal member 12 which is preferably integrally formed and equipped on a distal end with a ball mount affixed (e.g., welded) thereon, trailer hitch play or wobbling (and/or knocking sounds) attributable to apparatus having one or more jointed horizontally-aligned or inter-fitting components is eliminated. When any or all tasks are completed, a lock-pin retaining the apparatus 10 within a trailer hitch receiver e.g., fully extending through a pin aperture 58 of an elongate horizontal member 12 and corresponding apertures of the receiver, can be removed, which in turn, allows the apparatus 10 to be removed and stored for subsequent use, or employed on another vehicle.

In FIGS. 3A-3C and FIGS. 4A-4B a lower end 84 of an elongate obtuse-angled winch support member 14 is shown normally adjacent an upper side 22 of an elongate horizontal member 12. However it is noted that an obtuse-angled winch support member 14 can instead be substantially reduced in length, or made as a plurality of spaced apart short-length elements. For example, when welded or affixed (in a previously described manner) intermediate inward-facing sides of two elongate gusset plates 50 having a combined thickness and strength (when secured in a fixed pivot position) sufficient to meet or exceed a pull-force of a corresponding winch 42. Additionally one or more reduced in length or short-length elements can be located intermediate an inward-facing side of a single, or a pair of, elongate gusset plate(s) 50 to function as a pivot stop e.g., when pivoted adjacent an upper side 22 of a horizontal member, or a surface of a ball mount 32 or attached ball 34.

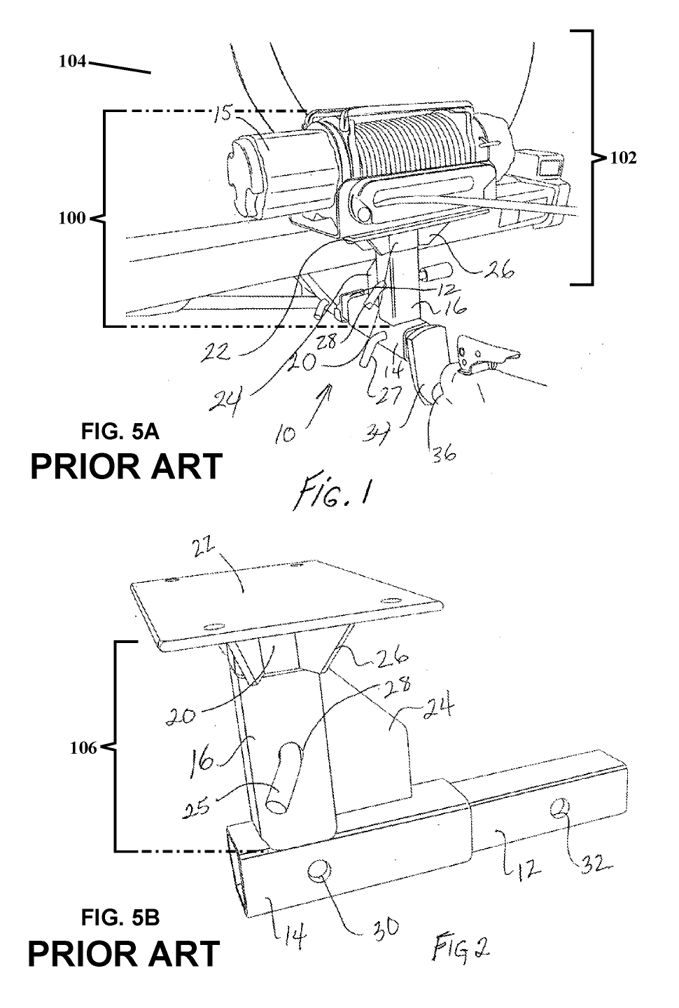

In reference to FIGS. 5A and 5B, two hand-drawn three-dimensional figures of a “Prior Art” reference ‘Thompson Ser. No. 10/653,810’ (described in the Background of the Invention section above) are shown, namely: “FIG. 1” and “FIG. 2” (respectively). In FIG. 5A, it can be seen that a combined ‘jointed’ height 100 of a “vertical steel tube 16”, vertically inserted winch mount and winch 15 mounted thereabove (indicated between horizontal dashed lines to the right of bracket 100), are located closely proximate a hinged member 104 of a typical vehicle. It can also be seen that the combined ‘jointed height’ (100) of the components extends upward, well into a significant portion of a vehicle-end profile, indicated to the left of bracket 102. Thus configured, the hinged member is substantially restricted in movement, if not prohibited from movement (whether horizontally or vertically hinged) for example, when the vertically-aligned components are dormant, or when a winch 15 is employed. The close proximity of the vertically aligned components to the vehicle hinged member 104 and vehicle-end profile 102 do not address how at least a horizontally-hinged member would be sufficiently opened and allow a winch to be rotated 180° to employ a winch cable and hook (or fastener) interiorly within e.g., a truck bed or the interior of large or small van. For example, a lower horizontally-hinged member 104 such as pickup truck tailgate would lean rearward and on top of the winch, preventing an unimpeded path for its winch cable and hook to extend into and function within the bed of the pickup truck. Moreover, Thompson '810 does not teach or suggest the option to reverse a winch, winch cable and hook, or how such components would be operated in a reversed manner.

In contrast, the present invention employs an elongate horizontal member, configured along an outer end portion/upper surface, having an elongate obtuse-angled winch support member of 110° or greater, which extends both outwardly and upwardly to a winch mount. The obtuse-angled configuration locates an entire vehicle-facing side of the assembly and a winch mounted thereabove (whether fixed or configured pivotal over a pivot range) such that a significantly increased clearance and vehicle compatibility is provided to accommodate more varied vehicle-end profiles including those with recessed and conventionally mounted trailer hitch assemblies. The present invention also teaches different ways to reversibly configure its angled components (or one or elements thereof) such that a winch, winch cable and hook are employable to perform various tasks within a truck bed or interior of a vehicle or van.

In reference to FIG. 5B (prior art “FIG. 2”), the combined ‘jointed height’ 106 of the two inter-fitting vertically-aligned members 16 and 26 (shown to the right of bracket) are sufficient in height when a winch 15 is also mounted thereabove, to not be compatible with certain recessed trailer hitch receivers and/or vehicle-end profiles immediately above and rearward the insertion ports of such. For example, wherein an exterior of the prior art winch comes into contact with a lower vehicle-end profile before the end of the horizontal member can come into alignment with the receiver's end port. In contrast, the present invention obtuse-angled components take into account the recessed location of such receivers, and their proximate vehicle-end profiles, such that significantly more-varied vehicles (and their vehicle-end profiles) are accommodated.

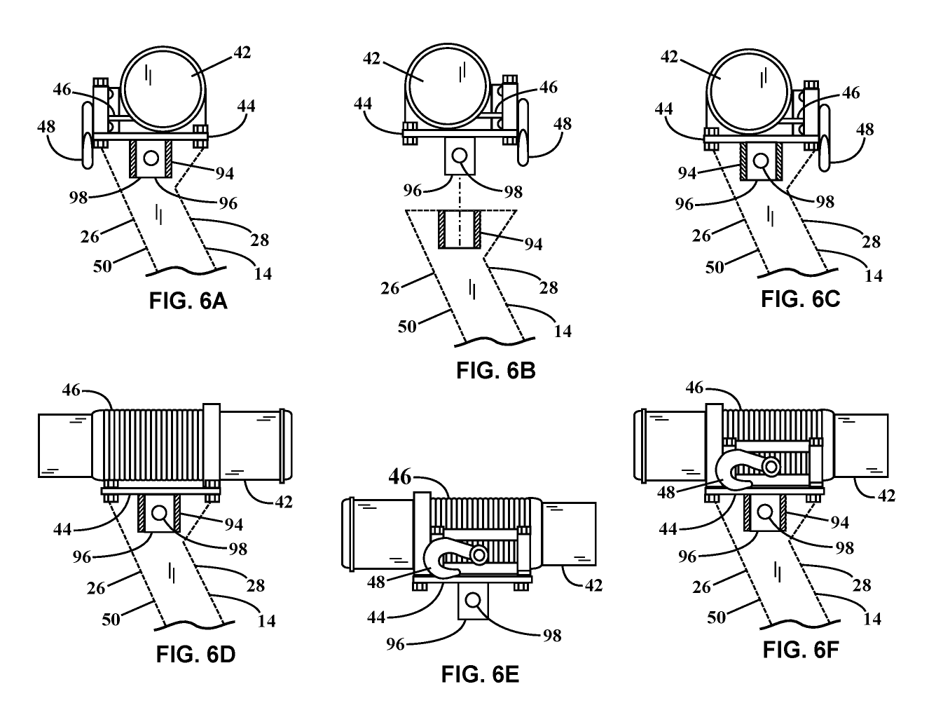

In reference to the two-dimensional views of FIGS. 6A-6F, an upper portion of an elongate obtuse-angled winch support member 14 is depicted, preferably having, welded or otherwise positively affixed to one, or to each, of its outward-facing sides, an elongate gusset plate 50. To facilitate a focusing on an interior of the upper portion the elongate obtuse-angled winch support member 14 is depicted having a dashed-line outline. Welded, mounted or formed upright in the interior of the upper portion of the winch support member 14 is a multi-sided receiver tube or socket 94 (opposite rearward-facing and forward-facing walls of which are depicted in cross-section). As previously described, and as depicted in at least FIGS. 6B and 6E, a bottom side of a winch mounting plate 44 is configured having a downwardly extending multi-sided receiver-insert 96. A multi-sided receiver-insert 96 and a corresponding multi-sided receiver tube or socket 94 are preferably configured having the same number of sides, such that a receiver-insert 96 of a given number of sides, slidably fits within a corresponding multi-sided receiver tube or socket 94 having the same number of sides with minimal or no play. For example, a multi-sided receiver-insert 96 can have a transverse polygonal cross-section having three or more sides, and preferably having an even number of sides e.g., 4, 6 or 8, such that lock-pin aperture 98 can be formed extending through one or more pairs of a receiver-insert's opposite sides. Thus, a downwardly extending multi-sided receiver-insert 96 removably securable in a corresponding multi-sided receiver tube or socket having a same number of sides, can: when having four sides, provide a minimum of 90° and/or maximum of 180° winch rotations that can be selectively made and secured (e.g., when having two/intersecting traverse apertures); and, when having six sides (with each pair of opposite sides having a respective transverse aperture or passageway), a minimum of 45° winch rotations are also provided, and so forth.

For the purposes of providing an ease of understanding a somewhat simplified illustration is provided, wherein FIGS. 6A through 6F each depicted a simpler four-sided receiver-insert 96. In each of FIGS. 6A-6F, the selectively rotatably-positionable components comprise a receiver-insert 96, a winch mounting plate 44 attached to an upper end of the receiver-insert, a winch 42 secured to the winch mounting plate, a winch cable 46 of the winch, and winch hook 48 or fastener attached to an outer end of the winch cable. In FIG. 6A the winch, winch cable and winch hook are selectively rotatably-positioned to face rearward. In FIG. 6B and FIG. 6C the same components are rotatably-positioned 180° to face forward and to operate freely adjacent an end of a vehicle. In FIG. 6D the components are rotatably-positioned 90° relative to FIG. 6A (e.g., CCW when viewed from above) such that a back side of the winch 42 is seen. In FIGS. 6E and 6F the components are rotatably-positioned 90° relative to FIG. 6A (e.g., CW when viewed from above) such that a front side of the winch 42 is seen.

A four-sided receiver-insert 96 can be configured with a single or cross-wise transverse apertures 98, which are located on a receiver-insert so as to align with a corresponding aperture or cylindrical passageway configured extending transversely through one or both gusset plate(s) 50 and/or the sides of an elongate winch support member 14. To facilitate a more positive retention of a multi-sided receiver-insert 96 within a corresponding multi-sided receiver tube or socket 94, the receiver-insert can be configured about an outer surface with a horizontal annular recess alignable with one or more threaded fasteners, wherein, the apertures of one or both gusset plate(s) 50 and/or the sides of an elongate winch support member 14 are threaded, such that a distal end of the one or more threaded fasteners can each be tightened into and positively engage a portion of the annular recess following an insertion of a receiver-insert. Alternatively, a receiver-insert can be configured on one or more sides having an indent, or somewhat recessed aperture which positively receives an end of a respective tightened threaded-fastener. In either case, a multi-sided receiver-insert 96 can be made securable within an upright or vertical receiver or socket 94 in a removably securable manner by suitable removable fasteners, for example, by one or more set screws, thumb screws, or one or more spring-loaded pins that can be momentarily pulled to disengage a respective aperture, indent or annular recess and released to selectively engage the same. In each a multi-sided receiver-insert 96 is positively securable within an upright or vertical receiver or socket 94 and all components of the apparatus, welds and/or joint as configured above, are made of a material having sufficient strength to meet or exceed the pull capacity of a corresponding mounted winch 42.

What is claimed is:

1. A trailer ball mount and elongate obtuse-angled winch support incorporating apparatus, comprising:
a lower elongate tube member configured at a trailer receiver-tube engaging end portion for being inserted into and releasably mounted, in a generally horizontal orientation, within a receiver tube of a vehicle-mounted trailer hitch receiver;
said lower elongate tube member configured at a distal end integrally formed with a trailer ball mount, and configured along an intermediate portion between said ball mount and said end portion such that opposite vertical side portions of the lower elongate tube member each have a pair of horizontally spaced apart apertures;
an upper elongate tube member normally retained adjacently above the intermediate portion of the lower elongate tube member and at an upwardly and outwardly extending obtuse angle relative thereto, wherein, a portion of, or entire, opposite vertical sides of the upper elongate tube member each comprise an adjoining planar gusset, and wherein each gusset further comprises a downwardly extending normally wider than tall gusset lower portion having a pair of horizontally spaced apart apertures, and said upper elongate tube member further configured at an upper end integrally formed with a bottom surface of a winch mount;
a first aperture pair located in a first gusset lower portion and a second aperture pair located in an opposing second gusset lower portion each configured adjacently alignable with a respective third aperture pair located in a first vertical side of, and fourth aperture pair located in an opposing second vertical side of, the lower elongate tube member, such that,
the aperture pairs of the first and second gusset lower portions when aligned with the aperture pairs of the first and second vertical sides of the lower elongate tube member allow for a first releasably retainable pin or fastener to be positioned in transversely aligned forward apertures of the aperture pairs, and/or a second releasably retainable pin or fastener to be positioned in transversely aligned rearward apertures of the aperture pairs, wherein,
the upper elongate tube member is rendered: a.) retained at an obtuse angle when the first and second releasably retainable pins or fasteners are each positioned respectively in a transversely aligned set of apertures, b.) pivotally movable over a range of angles when a single releasably retainable pin or fastener is positioned in a transversely aligned set of apertures, c.) removable from, or alignable with, the lower elongate tube member when no pin or fastener is employed; and wherein,
a winch, when mounted securely atop a winch mount of said upper elongate tube member retained at an obtuse angle so as to be spaced away from a vehicle, and a trailer ball when fastened securely to said trailer ball mount, are configured simultaneously or separately employable.

2. The apparatus of claim 1 wherein said lower elongate tube member and said upper elongate tube member are each made of a contiguously formed material having a square-tube or a rectangular-tube cross-section and of sufficient strength with reinforcement of said planar gussets to meet or exceed a pull-force of a corresponding mounted winch.

3. The apparatus of claim 1 wherein, the apparatus material is in part or entirely made of at least one of graphene, steel, an alloy, a composite.

4. The apparatus of claim 2 wherein the length of the upper elongate tube member normally retained at an upwardly and outwardly extending obtuse angle adjacent above and relative to the intermediate portion of the lower elongate tube member, is spaced away from a corresponding vehicle such that at least an outer portion of the winch is aligned vertically above a portion of the trailer ball mount; and,
is of sufficient height for an aligning of a winch cable extending outwardly from a winch mounted on said winch mount and a cable hook of the cable connecting to a portion of a vehicle or watercraft, to facilitate a pulling of the vehicle or watercraft onto a trailer, or onto a fenced trailer with the cable passing through a fence gap, when the trailer is coupled to the trailer ball of said apparatus, such that cable wear and tear, or cable abrasion, to an outwardly extended cable portion is substantially reduced or eliminated.

5. The apparatus of claim 1 wherein, said upper elongate tube member normally retained at a first upwardly extending obtuse angle adjacent above and relative to the intermediate portion of the lower elongate tube member, is configured positionable to and retained at a reversed second upwardly extending obtuse angle adjacent the intermediate portion, by a removal of said first and second releasably retainable pins or fasteners, a rotating of the upper elongate tube member 180 degrees and an aligning of the upper elongate tube member such that the aperture pairs of the first and second gusset lower portions are aligned with the aperture pairs of the first and second vertical sides of the lower elongate tube member, and said first and second releasably retainable pins or fasteners each positioned respectively in a transversely aligned set of apertures.

6. The apparatus of claim 1 wherein, said upper elongate tube member normally retained at a first upwardly extending obtuse angle is rendered pivotally movable about a single releasably retainable pin or fastener positioned in one of a forward set of transversely aligned apertures, a rearward set of transversely aligned apertures, over a range of angles including an angle wherein the upper elongate tube member is parallel or approximately parallel with that of said lower elongate tube member, such that,
a pivotally movable tailgate of a vehicle, or each pivotally movable door of a vehicle, to which the apparatus is releasably mounted and is nearby, are pivotally movable over an entire pivot range, or substantially entire pivot range, normally provided by the vehicle.

7. The apparatus of claim 1 wherein, an acute angled profile portion of the apparatus located adjacent a vertex at a lower end of said upper elongate tube member and an adjacent upper side of said lower elongate tube member, and/or located adjacent a vertex at an upper end of said upper elongate tube member and an adjacent underside of said winch mount, is/are integrally formed with two adjacent sides of, and reinforced by, a generally triangular shaped gusset made of a same or similar size square-tube or a rectangular-tube material as that of the lower and upper elongate tube members.

8. The apparatus of claim 7 wherein at least one of, a first outward-facing vertical side, each of a first and an opposite second outward-facing vertical side of, said upper elongate tube member and said lower elongate tube member, is integrally formed with an inward-facing side of a planar metal plate gusset; wherein,
a planar metal plate gusset covers and reinforces most or all of a respective outward-facing vertical side profile of the upper elongate tube member inclusive of one or more of said triangular shaped gussets, and most or all of a respective outward-facing vertical side of the intermediate portion of the lower elongate tube member.

9. The apparatus of claim 1 further comprising a reinforcing upright tube support member configured at a lower end for being centered about and supported by an upward-facing surface normally surrounding a mounted trailer ball, or configured at a lower end for being aligned and supported atop said lower elongate tube member;
said reinforcing upright support member configured at an upper end for supporting a normally forward-facing side, or a normally rearward-facing side, of a pivotally movable upper elongate tube member pivoted into contact with one of an uppermost end of an upright tube support member, an upper end of an upright tube support member configured having a pivotally mounted elongate tube member support thereon.

10. A trailer ball mount and elongate obtuse-angled winch support incorporating apparatus, comprising:
a lower elongate tube member configured at a trailer receiver-tube engaging end portion for being inserted into and releasably mounted, in a generally horizontal orientation, within a receiver tube of a vehicle-mounted trailer hitch receiver;
said lower elongate tube member configured at a distal end integrally formed with a trailer ball mount such that at least an upper portion of trailer hitch ball is in alignment with the elongate tube, and further configured along an intermediate portion between said ball mount and said end portion such that a first vertical side portion and an opposite second vertical side portion of the lower elongate tube member each has an aperture located nearby said distal end,
a portion of an upper surface of the lower elongate tube member located nearby said distal end configured adjoining an underside of a lower leaf of a hinge, wherein an outer surface of an upper leaf of the hinge is configured adjoining a lower forward-facing portion of an upper elongate tube member;
said upper elongate tube member normally retained adjacently above the intermediate portion of the lower elongate tube member and at an upwardly and outwardly extending obtuse angle relative thereto, wherein, a portion of, or entire, opposite vertical sides of the upper elongate tube member each comprise an adjoining planar gusset, wherein each gusset further comprises a downwardly extending normally wider than tall gusset lower portion each having an aperture located nearby said distal end, and said upper elongate tube member further configured at an upper end integrally formed with a bottom surface of a winch mount;
a first aperture located in a first gusset lower portion and a second aperture located in an opposing second gusset lower portion each configured adjacently alignable with a respective third aperture located in a first vertical side of, and fourth aperture located in an opposing second vertical side of, the lower elongate tube member, such that,
the apertures of the first and second gusset lower portions when aligned with the apertures of the first and second vertical sides of the lower elongate tube member allow for a releasably retainable pin or fastener to be transversely positioned in the aligned apertures, wherein,
the upper elongate tube member is rendered retained at an obtuse angle when a releasably retainable pin or fastener is transversely positioned in the aligned apertures, or is rendered pivotally movable over a range of angles about a pivot point of the hinge when a single releasably retainable pin or fastener is removed from the transversely aligned apertures; and wherein,
a winch when mounted securely atop a winch mount of said upper elongate tube member retained at an obtuse angle so as to be spaced away from a vehicle, and a trailer ball when fastened securely to said trailer ball mount, are configured simultaneously or separately employable.

11. The apparatus of claim 11 wherein said lower elongate tube member and said upper elongate tube member are each made of a contiguously formed material having a square-tube or a rectangular-tube cross-section and of sufficient strength with reinforcement of said planar gussets to meet or exceed a pull-force of a corresponding mounted winch.

12. The apparatus of claim 11 wherein, the apparatus material is in part or entirely made of at least one of graphene, steel, an alloy, a composite.

13. The apparatus of claim 11 wherein the length of the upper elongate tube member normally retained at an upwardly and outwardly extending obtuse angle adjacent above and relative to the intermediate portion of the lower elongate tube member, is spaced away from a corresponding vehicle such that at least a portion of the winch is aligned vertically above a portion of the trailer ball mount; and,
is of sufficient height for an aligning of a winch cable extending outwardly from a winch mounted on said winch mount and a cable hook of the cable connecting to a portion of a vehicle or watercraft, to facilitate a pulling of the vehicle or watercraft onto a trailer, or onto a fenced trailer with the cable passing through a fence gap, when the trailer is coupled to the trailer ball of said apparatus, such that cable wear and tear, or cable abrasion, to an outwardly extended cable portion is substantially reduced or eliminated.

14. The apparatus of claim 11 wherein, said upper elongate tube member normally retained at a first upwardly extending obtuse angle is rendered pivotally movable about a single releasably retainable pin or fastener positioned in a set of transversely aligned apertures, over a range of angles including an angle wherein the upper elongate tube member is parallel or approximately parallel with that of said lower elongate tube member, such that,
a pivotally movable tailgate of a vehicle, or each pivotally movable door of a vehicle, to which the apparatus is releasably mounted and is nearby, are pivotally movable over an entire pivot range, or substantially entire pivot range, normally provided by the vehicle.

15. The apparatus of claim 11 further comprising a reinforcing upright tube support member configured at a lower end for being centered about, and supported by an upward-facing surface normally surrounding, a mounted trailer ball, or centered and supported atop said lower elongate tube member;
said reinforcing upright support member configured at an upper end for supporting a normally forward-facing side, or a normally rearward-facing side, of a pivotally movable upper elongate tube member pivoted into contact with one of an uppermost end of an upright tube support member, an upper end of an upright tube support member configured having a pivotally mounted elongate tube member support thereon.

16. A trailer ball mount and elongate obtuse-angled winch support incorporating apparatus, comprising:
a lower elongate tube member configured at a trailer receiver-tube engaging end portion for being inserted into and releasably mounted, in a generally horizontal orientation, within a receiver tube of a vehicle-mounted trailer hitch receiver;
said lower elongate tube member configured at a distal end integrally formed with a trailer ball mount, and configured along an intermediate portion between said ball mount and said end portion having a first vertical side portion and an opposite second vertical side portion;
said upper elongate tube member mounted adjacently above the intermediate portion of the lower elongate tube member and at an upwardly and outwardly extending obtuse angle relative thereto, wherein, a portion of, or entire, opposite vertical sides of the upper elongate tube member each comprise an adjoining planar gusset, wherein each gusset further comprises a downwardly extending widened gusset lower portion having an inward-facing side integrally formed with an outward-facing side of the intermediate portion of the lower elongate tube member;
the upper elongate tube member further configured at an upper end integrally formed with a bottom surface of a winch mount; wherein,
a winch when mounted securely atop a winch mount of the obtuse angled upper elongate tube member so as to be spaced away from a vehicle, and a trailer ball when fastened securely to said trailer ball mount, are configured simultaneously or separately employable.

17. The apparatus of claim 16 wherein said lower elongate tube member and said upper elongate tube member are each made of a contiguously formed sturdy and durable material and having a square-tube or a rectangular-tube cross-section, and wherein,
said material is in part or entirely made of at least one of graphene, steel, an alloy, a composite.

18. The apparatus of claim 1 wherein, an acute angled profile portion of the apparatus located adjacent a vertex at a lower end of said upper elongate tube member and an adjacent upper side of said lower elongate tube member, and/or located adjacent a vertex at an upper end of said upper elongate tube member and an adjacent underside of said winch mount, is/are integrally formed with two adjacent sides of, and reinforced by, a generally triangular shaped gusset made of a same or similar size square-tube or a rectangular-tube material as that of the lower and upper elongate tube members.

19. The apparatus of claim 18 wherein at least one of, a first outward-facing vertical side, each of a first and an opposite second outward-facing vertical side of, said upper elongate tube member and said lower elongate tube member, is integrally formed with an inward-facing side of a planar metal plate gusset; wherein,
a planar metal plate gusset covers and reinforces most or all of a respective outward-facing vertical side profile of the upper elongate tube member inclusive of one or more of said triangular shaped gussets, and most or all of a respective outward-facing vertical side of the intermediate portion of the lower elongate tube member.

20. The apparatus of claim 16 further comprising, an upper end of said upper elongate tube member having a recessed upward-facing socket or receiver tube with interior sides thereof being polygonal in cross-section;
an underside surface portion of said winch mount further comprising a normally downwardly extending socket or receiver insert member sized and shaped to be inserted into the socket or receiver tube and configured to be releasably fastened therein with minimal or no play, wherein,
a winch securely mounted atop the winch mount is selectively rotatable from a first releasably fastened selected position to a next selected rotated position by a unfastening and removal of the insert member from the socket or receiver tube, a rotating of the insert member into alignment with said next selected rotated position, inserting and releasably fastening the insert member therein, in accordance with the polygonal cross-section sides available within the socket or receiver tube and the receiver insert member configured releasably fastenable therein.

21. The apparatus of claim 1 further comprising one or more reinforcing upright tube support members, wherein a reinforcing upright tube support member is configured positionable in an upright manner, at an upper end, intermediate and adjacently supporting a lower side portion of either a mounted said lower elongate tube member or a said trailer ball mount thereof, and at a lower end adjacently supported by a surface located vertically below the lower elongate tube member or the trailer ball mount, so as to bear a downward load or force associated with an operation of a respective mounted winch;
said reinforcing upright tube support member further comprising a tube material of sufficient grade to withstand said downward force or load, and configured supported in either or both of a jack-stand like manner, an interfitting arrangement occurring between said upper end and said lower side; and,
said reinforcing upright tube support member further configured having either a fixed height or an adjustable height.

22. The apparatus of claim 11 further comprising one or more reinforcing upright tube support members, wherein a reinforcing upright tube support member is configured positionable in an upright manner, at an upper end, intermediate and adjacently supporting a lower side portion of either a mounted said lower elongate tube member or a said trailer ball mount thereof, and at a lower end adjacently supported by a surface located vertically below the lower elongate tube member or the trailer ball mount, so as to bear a downward load or force associated with an operation of a respective mounted winch;
said reinforcing upright tube support member further comprising a tube or pipe material of sufficient grade to withstand said downward force or load, and configured supported in either or both of a jack-stand like manner, an interfitting arrangement occurring between said upper end and said lower side; and,
said reinforcing upright tube support member further configured having either a fixed height or an adjustable height.
